(19) United States
(12) Patent Application Publication
(10) Pub. No.: US 2023/0162083 A1
(43) Pub. Date: May 25, 2023

(54) TECHNIQUES FOR DETECTING AND SUGGESTING FIXES FOR DATA ERRORS IN DIGITAL REPRESENTATIONS OF INFRASTRUCTURE

(71) Applicant: Bentley Systems, Incorporated, Exton, PA (US)

(72) Inventors: Marc-André Gardner, Quebec City (CA); Simon Savary, Quebec City (CA); Michael Horsfall, Spicewood, TX (US); Christian delaPena, Round Rock, TX (US); Derek Holtman, Lago Vista, TX (US); Alfredo Contreras, Helotes, TX (US); Michael Carlisle, Austin, TX (US)

(21) Appl. No.: 17/532,402

(22) Filed: Nov. 22, 2021

(51) Int. Cl. G06N 20/00; G06N 5/02

(52) U.S. Cl. CPC G06N 20/00; G06N 5/02

(57) ABSTRACT

In example embodiments, machine learning techniques are provided for ensuring quality and consistency of the data in a digital representation of infrastructure (e.g., a BIM or digital twin). A machine learning model learns the structure of the digital representation of infrastructure, and then detects and suggests fixes for data errors. The machine learning model may include an embedding generator, an autoencoder, and decoding logic, employing embeddings and metamorphic truth to enable the handling of heterogenous data, with missing and erroneous property values. The machine learning model may be trained in an unsupervised manner from the digital representation of infrastructure itself (e.g., by assuming that a significant portion is correct). An SME review workflow may be provided to correct predictions and inject ground truth to improve performance.

### BACKGROUND

### Technical Field

The present disclosure relates generally to machine learning, and more specifically to application of machine learning to the detection and suggestion of fixes for data errors in digital representations of infrastructure.

### Background Information

As part of the design, construction and operation of infrastructure (e.g., electrical networks, gas networks, water and/or wastewater networks, rail networks, road networks, buildings, plants, bridges, etc.) it is often desirable to create digital representations of the infrastructure, where each component in the infrastructure is represented by a detail counterpart. A digital representation may take the form of a built infrastructure model (BIM) or a digital twin of the infrastructure. A BIM is a digital representation as it should be built, providing a mechanism for visualization and collaboration. A digital twin is a digital representation of infrastructure as it is actually built, and is often synchronized with information representing current status, working conditions, position, or other qualities.

To create a digital representation of infrastructure (e.g., a BIM or digital twin), one typically imports data describing the components from multiple different data sources. This imported data typical includes information describing the type (e.g., class) of each component, as well as the properties of each component. There is typically a large number of components, dispersed across many types (e.g., classes), each of which may have a different number and/or selection of properties. Depending on the properties, their values may be discrete or continuous. For example, where the infrastructure is an electrical network (e.g., of a medium-sized city) there may be several hundred thousand components, arranged into several dozen types (classes), each with about 3 to 15 properties (the number and selection of properties differing for each type of component). Some of these 3 to 15 properties may be discrete and others may be continuous.

Ensuring quality and consistency of this sort of heterogenous data in a digital representation of infrastructure presents a significant technical challenge. Imported data often includes large numbers of missing and erroneous property values, due to sourcing from incomplete or unreliable data sources, data corruption, human error and/or other factors. If missing/erroneous property values are not fixed, the digital representation of infrastructure may be unreliable or unusable.

Existing techniques for addressing data errors in a digital representation of infrastructure may be broadly classified into manual techniques, scripting language-based techniques, and Extract-Transform-Load (ETL)/Extract-Load-Transform (ELT) techniques. In manual techniques, a subject matter expert (SME), who is usually an experienced engineer, looks through the entirety of the imported data, and examines properties of each component to detect any erroneous/missing property values. The SME then, based on their technical understanding, fills in any missing property values and corrects any erroneous property values.

While usable on small projects, manual techniques have significant shortcomings. Foremost is that they do not scale, such that they become impractical as project size grows. For instance, considering the example above of an electrical network having several hundred thousand components, each with about 3 to 15 properties, manual techniques may require SME review of millions of individual property values. Even if the expense of all the engineer-hours required to conduct such review could be borne, reviewer fatigue may decrease the quality of review, such that significant missing/erroneous property values may still remain.

In scripting language-based techniques, a SME uses a scripting language to create custom rule-based algorithms, which are then applied to the imported data. Such rule-based algorithms are generally simplistic in nature, such that they look for particular predefined error types and, upon their detection, apply predefined fixes.

While usable with some types of simple data errors, rule-based algorithms are typically inadequate for addressing many types of data errors in digital representations of infrastructure. Infrastructure is typically very complex, and all the possible missing/erroneous property values that may be present in the data, and their appropriate fixes, typically cannot be foreseen beforehand and hand-coded into rules by a SME. As such, significant missing/erroneous property values may still remain after application of rule-based algorithms.

In ETL/ELT techniques, data science procedures are applied to validate, cleanse, and enrich data as it is being imported. ETL and ELT both share common stages of extraction (i.e., pulling the data from its original source), transformation (i.e., changing the structure of the data so it integrates with the target system), and loading (i.e., depositing the data in the storage of the target system). ETL and ELT differ in the ordering of these stages and their manner of execution. For example, ELT typically moves data from a data source to a staging area and transforms it before it is deposited. In contrast, ELT avoids data staging, and instead takes advantage of the target system to transform the data, which may result in better performance and flexibility.

While at least theoretically usable for addressing data errors in a digital representation of infrastructure, ETL/ELT techniques are not specifically designed for this use case and may require significant expertise to apply properly. Even if so applied, ETL/ELT techniques generally utilize rule-based algorithms, and therefore may suffer many shortcomings similar to scripting languages. Further, they may be biased towards specific error types and introduce additional errors in the transformation process. As such, significant missing/erroneous property values, as well as new data errors, may be present after application of ETL/ELT techniques.

Accordingly, there is a need for improved techniques for ensuring quality and consistency of the data in a digital representation of infrastructure. It would be useful if such techniques could both detect data errors, and suggest fixes for the data errors.

### SUMMARY

In example embodiments, machine learning techniques are provided for ensuring quality and consistency of the data in a digital representation of infrastructure (e.g., a BIM or digital twin). A machine learning model learns the structure of the digital representation of infrastructure, and then detects and suggests fixes for data errors. The machine learning model may include an embedding generator, an autoencoder, and decoding logic, employing embeddings and metamorphic truth to enable the handling of heterogenous data, with missing and erroneous property values. The machine learning model may be trained in an unsupervised manner from the digital representation of infrastructure itself (e.g., by assuming that a significant portion is correct). An SME review workflow may be provided to correct predictions and inject ground truth to improve performance.

It should be understood that a variety of additional features and alternative embodiments may be implemented other than those discussed in this Summary. This Summary is intended simply as a brief introduction to the reader and does not indicate or imply that the examples mentioned herein cover all aspects of the disclosure or are necessary or essential aspects of the disclosure.

### BRIEF DESCRIPTION OF THE DRAWINGS

The description below refers to the accompanying drawings of example embodiments, of which:

FIG. 1 is a high-level block diagram of an example application that uses machine learning to ensure quality and consistency of the data in a digital representation of infrastructure (e.g., a BIM or digital twin);

FIG. 2 is a high-level flow diagram for using machine learning to ensure quality and consistency of the data in a digital representation of infrastructure;

FIG. 3 is a diagram of an example graph representation of heterogeneous data that may be produced by a preprocessing module;

FIG. 4 is a diagram of an example architecture for an embedding generator that may be implemented by a machine learning model;

FIG. 5 is a diagram of a graph representation of homogenous data that may be produced by the embedding generator;

FIG. 6 is a diagram of an example machine learning model employing an autoencoder architecture;

FIG. 7 is a flow diagram of details of soliciting SME review of selected predictions for missing/erroneous property values; and

FIG. 8 is an example user interface that may display selected predictions for missing/erroneous property values.

### DETAILED DESCRIPTION

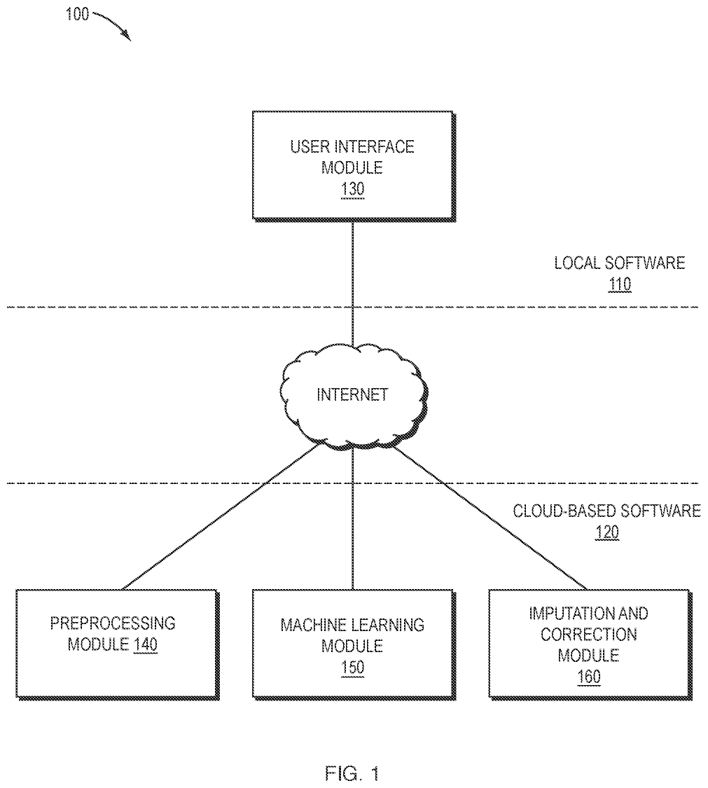

FIG. 1 is a high-level block diagram of an example application 100 that uses machine learning to ensure quality and consistency of the data in a digital representation of infrastructure (e.g., a BIM or digital twin). One example digital representation of infrastructure is a digital representation of an electrical network, that includes components that represent transformers, circuits, wires, etc. However, it should be understood that a digital representation of infrastructure may represent other types of infrastructure, for example, gas networks, water and/or wastewater networks, rail networks, road networks, buildings, plants, bridges, etc., and that the techniques discussed herein are not limited to use with electrical networks.

The application 100 may be a stand-alone software application or a component of a larger software application. In one example implementation, the application 100 is the Open Utilities™ digital twin services application, available from Bentley Systems, Inc. of Exton, Pa. However, it should be understood that the application 100 may take a variety of other forms. The application 100 may be divided into local software 110 that executes on one or more computing devices local to an end-user (collectively “local devices”) and, in some cases, cloud-based software 120 that executes on one or more computing devices remote from the end-user (collectively “cloud computing devices”) accessible via a network (e.g., the Internet). Each computing device may include processors, memory/storage, a display screen, and/or other hardware (not shown) for executing software, storing data and/or displaying information. The local software 110 may include a number of software modules operating on a local device, and in some cases within a web-browser of the local device, and the cloud-based software 120, if present, may include additional software modules operating on cloud computing devices.

Operations may be divided in a variety of different manners among the software modules. For example, in one implementation, software modules of the local software 110 may be responsible for performing non-processing intensive operations such as providing user interface functionality. To such end, the software modules of the local software 110 may include a user interface module 130, as well as other software modules (not shown). The software modules of the cloud-based software 120 may perform more processing intensive operations, such as operations related to machine learning. To such end, the software modules of the cloud-based software 120 may include a preprocessing module 140 that preprocesses a digital representation of infrastructure and ancillary data to facilitate machine leaning. The software modules of the cloud-based software 120 may also include a machine learning model 150 that learns the structure of the digital representation of infrastructure and then predicts values for missing/erroneous property values. As explained in more detail below, the machine learning model 150 may include an embedding generator, an autoencoder, and decoding logic. The software modules of the cloud-based software 120 may also include an imputation and correction module 160 that uses the predicted values to replace missing/erroneous property values, subject to SME review.

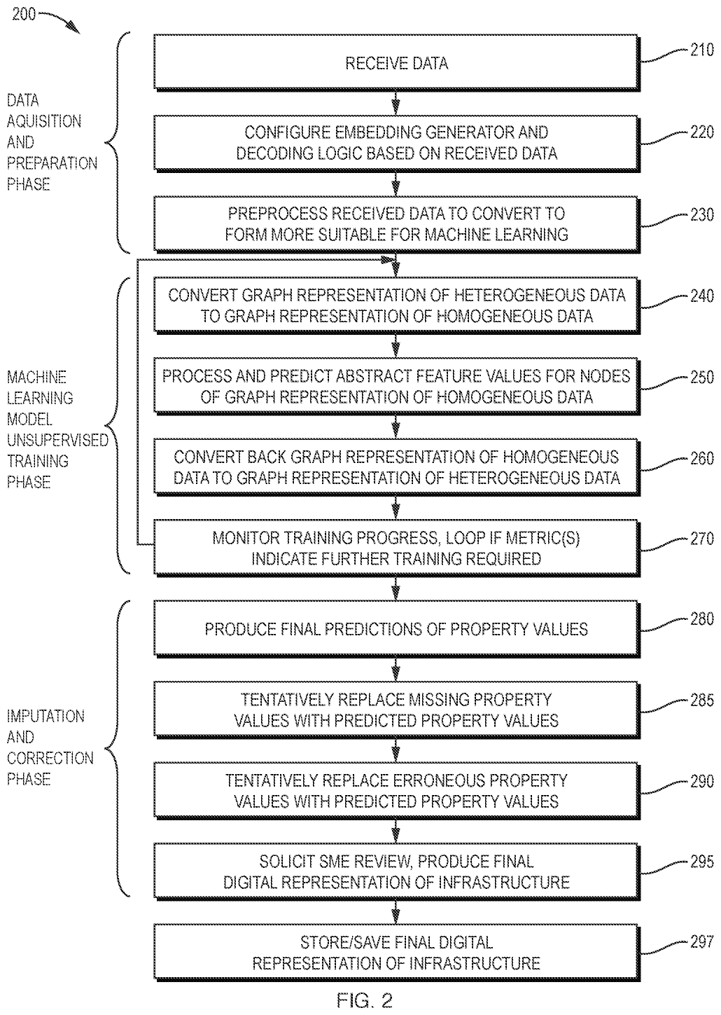

FIG. 2 is a high-level flow diagram 200 for using machine learning to ensure quality and consistency of the data in a digital representation of infrastructure. The steps of diagram 200 may be broadly segmented into three phases: a data acquisition and preparation phase, a machine learning model unsupervised training phase, and an inference and user feedback phase. At step 210 of the data acquisition and preparation phase, the preprocessing module 140 receives data. The received data may include data in the digital representation of infrastructure (e.g., a BIM or digital twin) and also error detection parameters and settings. The data in the digital representation of infrastructure may describe each component in the digital representation of infrastructure, including its type (e.g., class) and property values. Typically, a digital representation of infrastructure will include a large number of components, dispersed across many types (e.g., classes), each of which may have a different number and/or selection of properties, which may be discrete or continuous. In one specific implementation, the data in the digital representation of infrastructure may be structured according to an iModel® format. Each individual property value may be either present and valid, present and invalid (i.e., an erroneous property value) or absent (i.e., a missing property value). The error detection parameters and settings may include a list of components to check, a list of properties to check for each component, domain definitions (discrete or continuous) for properties, configurable thresholds, and/or other parameters and settings.

At step 220 of the data acquisition and preparation phase, the preprocessing module 140 configures an embedding generator and decoding logic based on the received data. As explained in more detail below, the machine learning model 150 may include an embedding generator that includes a number of component-type specific encoders that convert a heterogeneous representation of data into a homogenous representation of data. Likewise, the machine learning model may include decoding logic that converts a homogenous representation of data back into a heterogeneous representation of data. Configuration of the embedding generator and decoding logic may include selection of individual encoders and decoders based on component types in the received data (e.g., in the list of components to check) as well as other customizations based on the received data.

At step 230 of the data acquisition and preparation phase, the preprocessing module 140 preprocesses the received data to at least convert the digital representation of infrastructure to a form more suitable for machine learning. The conversion may include converting data in the digital representation of infrastructure to a graph representation, where each component is a node, and the nodes are connected by edges that indicate connections among components or parent/child relationships. For instance, in an example where the infrastructure is an electrical network, the nodes may represent transformers, circuits, wires, etc. and the edges may indicate that wires are connected to particular transformers, that circuits include particular wires, etc. Each node in the graph representation may be associated with the type (e.g., class) of the component and one or more properties of the component. As mentioned above, properties may be discrete or continuous. In this context “discrete” refers to taking on values that come from a specific and restrained set, and “continuous” refers to taking upon values that may fall within a range but that are not otherwise constrained. For instance, in an example where the infrastructure is an electrical network, the primary voltage of a transformer may be discrete (e.g., it may be 25 kV or 50 kV, but not 25.887 kV), while the length of a wire may be continuous (e.g., it may be any value greater than 0 but less than 100 m, such as 32.345 m). As part of the preprocess of step 230, the preprocessing module 140 may convert discrete properties to a one-hot vector representation (i.e., a vector that typically contains all zeros except one position that indicates the discrete value). As a special case, if a particular property value is missing, the one-hot vector may contain only zeros. Further, the preprocessing module 140 may normalize continuous properties (e.g., such that their values all have a mean of 0 and a standard deviation of 1). The preprocessing module 140 may concatenate the one-hot vector and the continuous values to produce a property value vector for each node of the graph representation. The resulting graph representation with a property value vector for each node may be considered heterogeneous. In this context, “heterogeneous” refers to data that that occupies multiple distinct and different spaces of potentially different dimensionalities for different members (e.g., types of components).

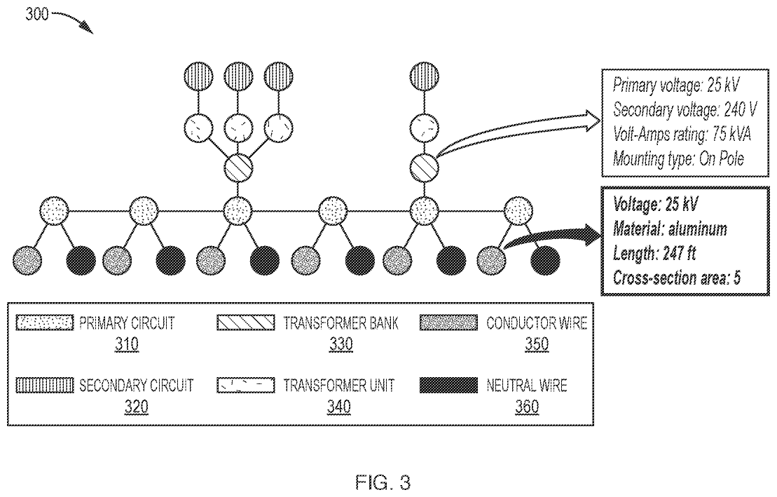

FIG. 3 is a diagram 300 of an example graph representation of heterogeneous data that may be produced by the preprocessing module 140 as a result of step 230 of FIG. 2. In this example, the graph representation of heterogeneous data is for components of an electrical network. Nodes of the graph represent circuits (including types of “primary circuit” 310 and “secondary circuit” 320, transformers (including types of “transformer bank” 330 and “transformer unit” 340) and wires (including types of “conductor wire” 350 and “neutral wire” 360) connected by edges that indicate connections among components or parent/child relationships. The data is heterogeneous as each type of component may include a different number and/or selection of properties, resulting in the data inhabiting different spaces for different types of components. For example, a transformer bank 330 may include properties of primary voltage, secondary voltage, volt-amp rating and mounting type, while a conductor wire 350 may include properties of voltage, material, length, and cross section area. While example property values are shown in a table form in FIG. 3, it should be understood that such property values may be represented as a property value vector as discussed above.

At step 240 of the machine learning model unsupervised training phase, the embedding generator of the machine learning model 150 converts the graph representation of heterogeneous data produced by the preprocessing module 140 to a graph representation of homogenous data. In this context, “homogenous” refers to data that occupies a common space across all members (e.g., across all components). Such a homogenous representation may be better suited for machine learning as it permits comparison and simultaneous processing across different types of components.

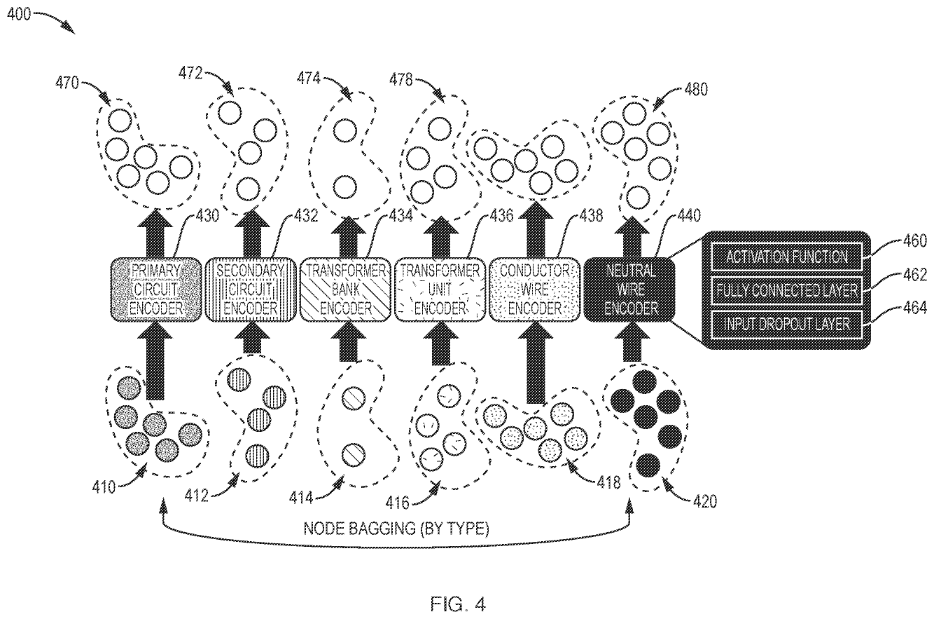

FIG. 4 is a diagram of an example architecture for an embedding generator that may be implemented by the machine learning model 150. Such diagram builds upon the example in FIG. 3, and as such also uses the example of components of an electrical network.

To convert the graph representation of heterogeneous data to a graph representation of homogenous data, the embedding generator may first group (“bag”) the nodes by their type. For example, as shown in FIG. 4, nodes that represent primary circuits may be grouped in a first bag 410, nodes that represent secondary circuits may be grouped in a second bag 412, nodes that represent transformer banks may be grouped in a third bag 414, and so forth. The nodes of each bag 410-420 are applied to individual encoders 430-440 that project the property value vector of each node into an abstract feature vector that inhabits a common space, thereby transforming a heterogeneous representation of data into a homogenous representation of data. The selection of the individual encoders may be configured as part of step 220, as discussed above. The number of abstract features in the abstract feature vector may also be configured as part of step 220, or set to a predetermined value (e.g., 32). Each individual encoder 430-440 may include a small neural network that learns mappings required to project a property value vector into an abstract feature vector. The architecture of such a neural network may be common across each individual encoder 430-440, for example, including an activation layer 460, a fully-connected layer 462, and an input dropout layer 464, however with different weights. The nodes with their new abstract feature vectors from individual encoder 430-440 may be arranged in groups (bags) 470-480 by type, similar to groups 410-420. The embedding generator may then perform graph replication to produce the graph representation of homogenous data from the grouped nodes.

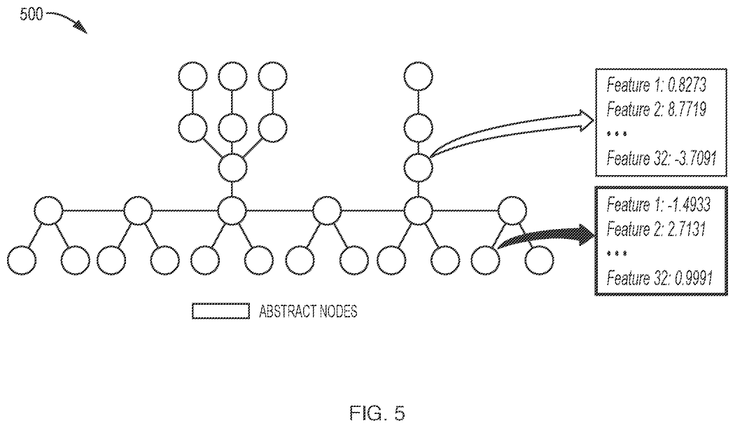

FIG. 5 is a diagram 500 of a graph representation of homogenous data that may be produced by the embedding generator as a result of step 240 of FIG. 2. Such diagram builds upon the example in FIG. 4, and as such also uses the example of components of an electrical network. Each of the nodes of the graph are associated with the same number of abstract features, whose values do not correspond to any single real-world significant quality. While abstract feature values are shown in a table form in FIG. 5, it should be understood that such feature values may be represented as an abstract features vector as discussed above.

At step 250 of the machine learning model unsupervised training phase, the machine learning model 150 processes and predicts abstract feature values for the nodes of the graph representation of homogenous data. The machine learning model may use an autoencoder architecture based on metamorphic truth, such that it learns to produce the same abstract feature values it sees as inputs as outputs. The autoencoder architecture may use graph attention networks (GATs). A GAT is a type of neural network that operates on graph-structured data and leverages masked self-attentional layers that when stacked are able to attend over their neighborhoods' features.

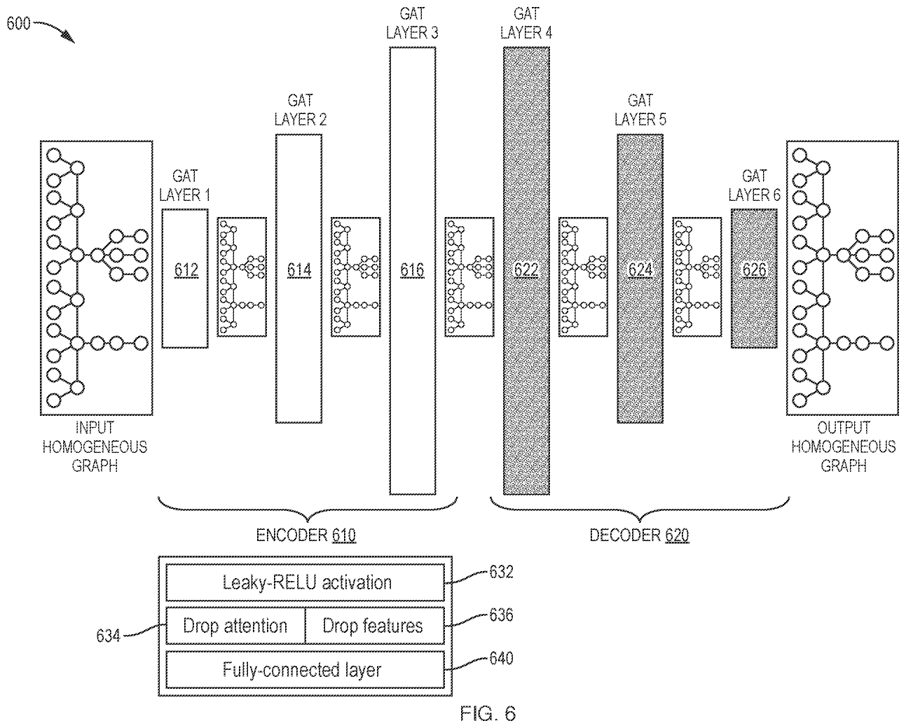

FIG. 6 is a diagram 600 of an example machine learning model employing an autoencoder architecture that may be used to implement step 250 of FIG. 2. In this example, the machine learning model takes as input the example graph representation of homogenous data shown in FIG. 5. The autoencoder architecture is structured as a mirrored stack of GAT layers divided into an encoder 610 and a decoder 620. In this example, the encoder 610 includes three GAT layers 612, 614, 616 with increasing numbers of fully connected units (e.g., 144, 192, 240) that generate a representation in low dimensionality latent space. The decoder 620 likewise includes three GAT layers 622, 624, 626 with increasing numbers of fully connected units (e.g., 192, 144, 32) that expand back the representation in low dimensionality latent space to a reconstructed graph representation of homogenous data. For present data, the learning target is the input. As such, for valid and present data the machine learning model should learn to propagate efficiently the input information through all the GAT layers 612-626 to the output, such that it reconstructs the input. For missing data, the learning target is the prediction itself. In training, the machine learning model 150 learns the broad principles guiding the underlying data distribution first. Once this is complete, most conflicts (i.e., where data is present, but the inputs do not match the outputs) are the result of erroneous property values. To avoid the erroneous property values from propagating too much into the training, the learning target in the case of conflicts may be gradually changed from being the input to being the output.

Each GAT layer 612-626 of the autoencoder architecture may include a number of sublayers, including a leaky-rectified linear unit (RELU) activation layer 632, a dropout layer (including a drop attention layer 634 and a drop features layer 636) and a fully-connected layer 640. The leaky-RELU activation layer 632 may implement a piecewise linear function that outputs its input directly if it is positive, but only passes small negative values when the input is less than zero. The dropout layer randomly hides (e.g., voids as if they were missing) a portion (e.g., 20%) of its input. In the dropout layer, the drop attention layer 634 may randomly hide nodes while the drop features layer 636 may randomly hide abstract features. Use of a dropout layer may improve performance and robustness by avoiding a pure “copy-paste” operation between inputs and outputs and forcing consideration of node neighbors.

At step 260 of the machine learning model unsupervised training phase, the decoding logic of the machine learning model 150 converts the reconstructed graph representation of homogenous data back into a graph representation of heterogeneous data, where each node is associated with a property value vector that indicates real-world significant qualities. The decoder logic of the machine learning model 150 may implement an architecture similar to the architecture of the embedding generator of FIG. 4, but in reverse. To convert the reconstructed graph representation of homogenous data back into a graph representation of heterogenous data, the machine learning model 150 may first group (bag) the nodes by their type. The nodes of each bag are applied to individual decoders, that operate in the reverse of encoders 430-440 of FIG. 4, to produce a property value vector from an abstract feature vector. The selection of the individual decoders may be configured as part of step 220, as discussed above. Again, each individual decoder may include a small neural network and the architecture of such neural networks may be common across each decoder. The nodes with their new property value vectors may be initially placed in groups, and then organized to produce the reconstructed graph representation of heterogeneous data by graph replication. Individual property values may be extracted from the property value vectors. The property values represent predictions of the property values for each component. The decoding logic of the machine learning model 150 may also associate each predicted property value with a confidence (e.g., produced in the underlying reconstruction operations).

At step 270 of the machine learning model unsupervised training phase, the application monitors training progress, and loops to step 240 if one or more metrics indicate further training is required. Various metrics may be examined alone or in combination. One metric may be a number of training iterations (e.g., specified in the error detection parameters and settings), and execution may loop to step 240 if a predetermined number of training iterations have not been completed. Another metric may be reconstruction loss for each component type and/or each property type, and execution may loop to step 240 if reconstruction loss fails to meet a predetermined minimum performance. In some implementations, reconstruction loss may be evaluated by applying the machine learning model to data where all values have been voided and comparing predictions to validation data.

At step 280 of the inference and user feedback phase, the graph representation of heterogeneous data is applied again to the now trained machine learning model 150 to produce final predictions for property values of components. Operations similar to steps 240-260 discussed above may be repeated, such that the embedding generator converts the graph representation of heterogeneous data to a graph representation of homogenous data, an autoencoder architecture processes and predicts abstract feature values for the nodes of the graph representation of homogenous data, and decoding logic converts the reconstructed graph representation of homogenous data back into a graph representation of heterogeneous data, and ultimately produces for each component predicted property values with respective confidences.

At step 285 of the inference and user feedback phase, the imputation and correction module 160 tentatively replaces missing property values in the digital representation of infrastructure with the predicted values for those property values from the final predictions. If there are multiple predicted values (as is typically the case), the predicted value with the greatest confidence may be selected and used for replacement. At least some of the predictions used in the tentative replacements of missing property values may be selected for SME review, as discussed further below. In one implementation, all predictions for missing property values may be selected for SME review. In an alternative implementation, some predictions are selected for SME review based on a comparison of confidence in the predictions to a missing value confidence threshold (which may be provided as part of the detection parameters and settings).

At step 290 of the inference and user feedback phase, the imputation and correction module 160 tentatively replaces erroneous property values in the digital representation of infrastructure with the predicted values for those property values from the final predictions. A property value may be considered erroneous based on a ratio between the confidence in the original property value and the confidence in the predicted property value with the greatest confidence. Where the ratio exceeds a threshold (e.g., 4×), the original property value may be considered erroneous and replaced with the predicted property value with the greatest confidence. In one implementation, all predictions used in the tentative replacement of erroneous property values may be selected for SME review. In an alternative implementation, some predictions are selected for SME review based on a comparison of the ratio to an erroneous value confidence threshold (which may be provided as part of the detection parameters and settings).

At step 295 of the inference and user feedback phase, the imputation and correction module 160 working together with the user interface module 130 solicits SME review of the predictions for missing/erroneous property values used in the tentative replacements in steps 285-290. If a prediction for a missing/erroneous property values is incorrect, the SME may be requested to enter themselves a replacement. Alternatively, the SME may be presented with N prediction alternatives with the highest confidences, and requested to select the correct property value from among them. This alternative can be particularly useful when a property has multiple possible values, and reducing the number of possibilities is helpful. Operation of step 295 produces a final digital representation of infrastructure. Ground truth from the SME review may also be fed back for use in further training of the machine learning model 150 to improve prediction in subsequent operation.

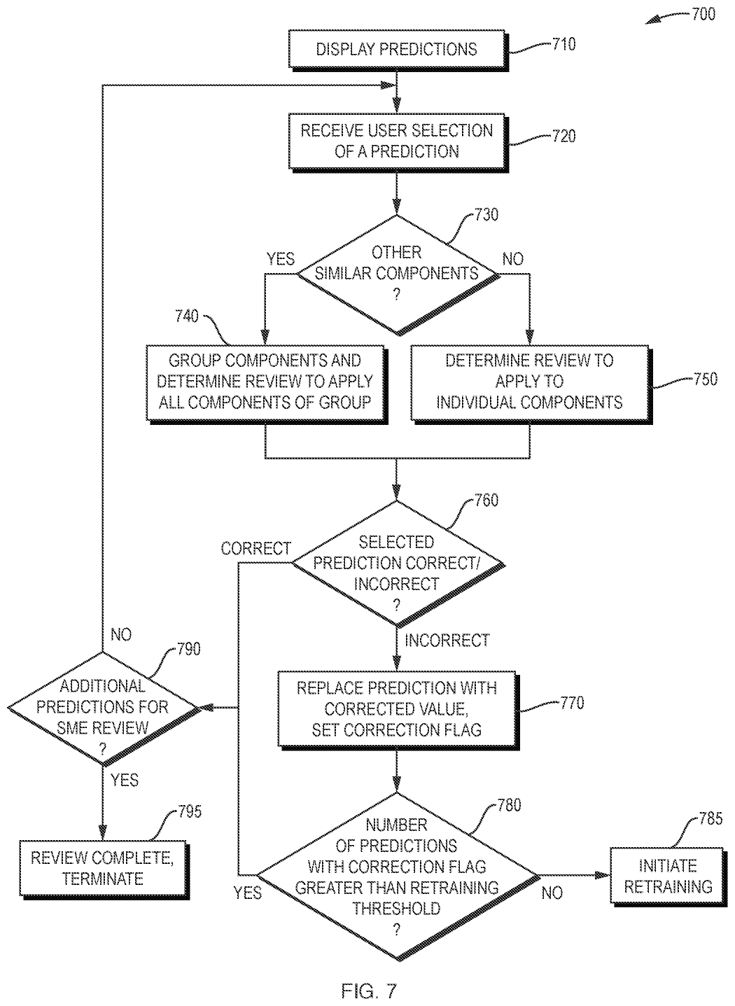

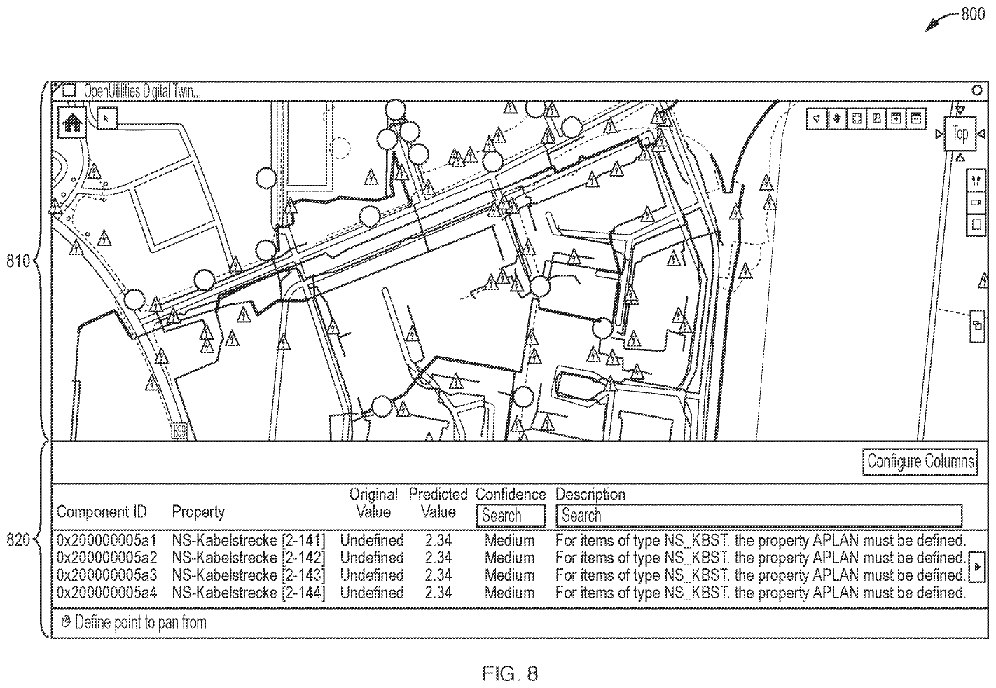

FIG. 7 is a flow diagram 700 of details of soliciting SME review of predictions for missing/erroneous property values, that may be performed as part of step 295 of FIG. 2. At step 710, the imputation and correction module 160 working together with the user interface module 130 displays selected predictions in a user interface. FIG. 8 is an example user interface 800 that may display selected predictions for missing/erroneous property values. In this example, the user interface shows selected predictions for values of components of an electrical network. However, it should be understood that the example user interface may be readily adapted for other types of infrastructure. A first portion 810 of the interface may show a map or diagram of the infrastructure (e.g., electrical network). Components with missing/erroneous property values that have been tentatively replaced by predictions may be indicated by icons (which may be grouped depending upon a zoom level). A second portion 820 of the interface may show details of individual predictions, including an original value, a predicted value, and a confidence for each component property that has been selected for SME review.

At step 720, the imputation and correction module 160 working together with the user interface module 130 receives a user selection of a prediction in the user interface. For example, referring to FIG. 8 the user may select (e.g., click upon) an individual prediction in the second portion 820 of the user interface. At step 730, the imputation and correction module 160 determines if there are other components similar to the component having the selected prediction. Components may be considered similar if they share a common type (e.g., class), share other common property values, and/or are otherwise associated with each other. If the component having the selected prediction is similar to other components, at step 740, the imputation and correction module 160 groups the components, and SME review is determined to apply to all components of the group. If the component having the selected prediction is not similar to other components, at step 750, the imputation and correction module 160 determines that the SME review is to apply only to the component having the selected prediction.

At step 760, the imputation and correction module 160 working together with the user interface module 130 receives a SME indication of whether the selected prediction is correct (and should be validated and saved) or incorrect (and should be rejected and fixed). When the selected prediction is incorrect, a corrected value may also be received. In some implementations, the indication that the selected prediction is correct or incorrect may be implicit. For example, referring to FIG. 8, if a SME selects (e.g., clicks upon) an individual prediction in the second portion 820 of the interface, and does not change the predicted value, it may be implicitly concluded that the prediction is correct, Alternatively, if the SME corrects (e.g., types in) a new value, it may be implicitly concluded that the prediction is incorrect.

If the SME indicated the selected prediction is incorrect, at step 770, the imputation and correction module 160 replaces the prediction (or group of predictions if the prediction was placed in a group in step 740) with the corrected value, and sets a correction flag for the prediction (or for each member of the group of predictions). Then, at step 780, the imputation and correction module 160 compares the number of predictions that have correction flags set to a retraining threshold. If the number exceeds the retraining threshold, at step 785, retraining of the machine learning model 150 is initiated. In such case, steps similar to those discussed in connection with step 240-270 of FIG. 2 may be repeated. If the number does not exceed the retraining threshold, at step 790, a determination is made whether there are additional predictions that require SME review. The determination may be made in response to user input in the user interface indicating SME review is complete. In some cases, a SME may indicate review is complete without individually selecting and indicating correct/incorrect status for each prediction. For example, the SME may review only those predictions having low confidence, and it may be assumed higher confidence predictions are correct. If it is determined there are additional predictions that require SME review, execution may loop back to step 720. Otherwise, execution may terminate at step 795.

Returning to FIG. 2, after SME review is complete, at step 297, the final digital representation of infrastructure may be stored to memory/storage for future use by the application 100 or another application, may be displayed by the user interface module 130 of the application 100 on the display screen, or may be otherwise utilized.

In summary, machine learning techniques are provided for ensuring quality and consistency of the data in a digital representation of infrastructure (e.g., a BIM or digital twin). The techniques may utilize a machine learning model that includes an embedding generator, an autoencoder, and decoding logic, employing embeddings and metamorphic truth to enable the handling of heterogenous data, with missing and erroneous property values. An SME review workflow may be provided to correct predictions and inject ground truth to improve performance. It should be understood that a wide variety of adaptations and modifications may be made to the architecture and techniques used therewith. It should be remembered that functionality may be implemented using different software, hardware, and various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

What is claimed is:

1. A method for enabling detection and suggestion of fixes for data errors in a digital representation of infrastructure, comprising:
receiving, by an application executing on one or more computing devices, data that includes the digital representation of infrastructure, wherein the digital representation of infrastructure has a plurality of components that each are associated with one or more property values;
preprocessing the received data to convert the digital representation of infrastructure to a graph representation of heterogenous data;
converting, by a plurality of encoders of a machine learning model of the application, the graph representation of heterogenous data to a graph representation of homogenous data, wherein the graph representation of homogenous data includes a plurality of nodes that are each associated with one or more abstract features;
processing, by the machine learning model, the abstract features to predict values for the nodes of the graph representation of homogenous data;
converting back, by a plurality of decoders of the machine learning model, the graph representation of homogeneous data to a reconstructed graph representation of heterogenous data; and
repeating the converting, processing, and converting back until one or more training metrics are satisfied, to train the machine learning model to be capable of detecting and suggesting fixes for missing and erroneous property values in the digital representation of infrastructure.

2. The method of claim 1, further comprising:
applying the graph representation of heterogenous data to the trained machine learning model and repeating the converting, processing, and converting back to produce final predictions; and
storing or displaying, by the application, a final digital representation of infrastructure that is based on the final predictions.

3. The method of claim 2, further comprising:
replacing missing property values of components in the digital representation of infrastructure with one or more first predicted property values from the final predictions; and
replacing erroneous property values in the digital representation of infrastructure with one or more second predicted property values from the final predictions,
wherein the final digital representation of infrastructure uses at least one of the one or more first predicted property values and the one or more second predicted property values.

4. The method of claim 3, further comprising:
soliciting subject matter expert (SME) review of predicted property values in the final predictions; and
correcting one or more of the predicted property values based on the SME review,
wherein the final digital representation of infrastructure also uses the corrections to the predicted property values.

5. The method of claim 4, further comprising:
comparing a number of corrections to the predicted property values from the SME review to a restraining threshold;
in response to the number of corrections to the predicted property values exceeding the retraining threshold, retraining the machine learning model by repeating the converting, processing, and converting back.

6. The method of claim 4, further comprising:
for at least one of the corrections to the predicted property values, determining one or more other components are similar to a component whose predicted property value is subject to correction;
applying a corresponding correction to predicted property values of the one or more other components.

7. The method of claim 1, wherein each encoder includes an activation function, a fully connected layer, and an input dropout layer.

8. The method of claim 1, wherein the processing is performed by an autoencoder architecture that utilizes metamorphic truth.

9. The method of claim 8, wherein the autoencoder architecture includes a plurality of graph attention network (GAT) layers, and the processing further comprises:
generating, by a first set of the GAT layers, a representation in latent space from the graph representation of homogenous data; and
expanding, by a second set of the GAT layers, the representation in latent space back to the reconstructed graph representation of homogenous data.

10. The method of claim 9, wherein each of the GAT layers includes a leaky-rectified linear unit (RELU) activation layer, a dropout layer and a fully-connected layer.

11. The method of claim 1, wherein the digital representation of infrastructure is a built infrastructure model (BIM) or a digital twin of infrastructure.

12. The method of claim 11, wherein the infrastructure is an electrical network.

13. A non-transitory electronic device readable medium having instructions stored thereon that when executed on one or more processors of one or more electronic devices are operable to:
receive data that includes a digital representation of infrastructure, wherein the digital representation of infrastructure has a plurality of components that each are associated with one or more property values;
preprocess the received data to convert the digital representation of infrastructure to a graph representation of heterogenous data;
apply unsupervised learning to train a machine learning model using the graph representation of heterogenous data obtained from the digital representation of infrastructure by
converting the graph representation of heterogenous data to a graph representation of homogenous data, wherein the graph representation of homogenous data includes a plurality of nodes that are each associated with one or more abstract features;
processing the abstract feature to predict values for the nodes of the graph representation of homogenous data;
converting back the graph representation of homogeneous data to a reconstructed graph representation of heterogenous data; and
apply the trained machine learning model again to the graph representation of heterogenous data obtained from the digital representation of infrastructure to produce final predictions; and
store or display a final digital representation of infrastructure that is based on the final predictions.

14. The non-transitory electronic device readable medium of claim 13, wherein the instructions when executed are further operable to:
replace missing property values of components in the digital representation of infrastructure with one or more first predicted property values from the final predictions; and
replace erroneous property values in the digital representation of infrastructure with one or more second predicted property values from the final predictions,
wherein the final digital representation of infrastructure uses at least one of the one or more first predicted property values and the one or more second predicted property values.

15. The non-transitory electronic device readable medium of claim 14, wherein the instructions when executed are further operable to:
solicit subject matter expert (SME) review of predicted property values in the final predictions; and
correct one or more of the predicted property values of the final predictions based on the SME review,
wherein the final digital representation of infrastructure also uses the corrections to the predicted property values.

16. The non-transitory electronic device readable medium of claim 15, wherein the instructions when executed are further operable to:
compare a number of corrections to the predicted property values from the SME review to a restraining threshold;
in response to the number of corrections to the predicted property values exceeding the retraining threshold, retrain the machine learning model.

17. The non-transitory electronic device readable medium of claim 15, wherein the instructions when executed are further operable to:
for at least one of the corrections to the predicted property values, determine one or more other components are similar to a component whose predicted property value is subject to correction; and
apply a corresponding correction to predicted property values of the one or more other components.

18. The non-transitory electronic device readable medium of claim 15, wherein the processing is performed by an autoencoder architecture that utilizes metamorphic truth.

19. The non-transitory electronic device readable medium of claim 18, wherein the autoencoder architecture includes a plurality of graph attention network (GAT) layers, and the processing comprises generating, by a first set of the GAT layers, a representation in latent space from the graph representation of homogenous data, and expanding, by a second set of the GAT layers, the representation in latent space back to the reconstructed graph representation of homogenous data.

20. The non-transitory electronic device readable medium of claim 13, wherein the digital representation of infrastructure is a built infrastructure model (BIM) or a digital twin of an electrical network.
